(19) United States
(12) Patent Application Publication
(10) Pub. No.: US 2015/0296198 A1
(43) Pub. Date: Oct. 15, 2015

(54) METHOD FOR ENCODING AND DECODING IMAGE USING DEPTH INFORMATION, AND DEVICE AND IMAGE SYSTEM USING SAME

(71) Applicant: INTELLECTUAL DISCOVERY CO., LTD., Seoul (KR)

(72) Inventors: Gwang Hoon Park, Seongnam-si (KR); Yoon Jin Lee, Yongin-si (KR); Dong In Bae, Yongin-si (KR); Kyung Yong Kim, Suwon-si (KR)

(73) Assignee: INTELLECTUAL DISCOVERY CO., LTD., Seoul (KR)

(21) Appl. No.: 14/647,675

(22) PCT Filed: Nov. 27, 2013
(86) PCT No.: PCT/KR2013/010875

§ 371 Date: May 27, 2015

(30) Foreign Application Priority Data
Nov. 27, 2012 (KR) 10-2012-0135666
Apr. 15, 2013 (KR) 10-2013-0040803
Apr. 15, 2013 (KR) 10-2013-0040807
Apr. 15, 2013 (KR) 10-2013-0040812

(51) Int. Cl. H04N 13/00; H04N 19/184; H04N 19/176

(52) U.S. Cl. CPC H04N 13/0048; H04N 19/176; H04N 19/184

(57) ABSTRACT

A method for decoding an image, according to one embodiment of the present invention, comprises the steps of: receiving encoded data; extracting depth information from the encoded data; decoding the encoded data by using the depth information; and obtaining a normal two-dimensional image from the decoded data by using the depth information.

### BACKGROUND OF THE INVENTION

1. Field of the Invention

The present invention relates to a method for efficiently encoding/decoding images using depth information and an encoding/decoding apparatus and image system using the same.

2. Related Art

Depth information images are widely used in three-dimensional video encoding, and a depth information camera equipped in new input devices, such as Kinect camera, may be utilized in various 3D applications.

Meanwhile, the 3D applications may become commonplace through a diversity of 2D/3D application services, and accordingly, as depth information cameras are included in multimedia camera systems in the future, various types of information may be utilized.

### SUMMARY OF THE INVENTION

The present invention aims to provide an image encoding and decoding method that may increase encoding efficiency while reducing complexity using depth information and an encoding/decoding apparatus and image system using the same.

To achieve the above objects, according to an embodiment of the present invention, a method for decoding an image comprises receiving encoded data; extracting depth information from the encoded data; decoding the encoded data using the depth information; and obtaining a 2D normal image from the decoded data using the depth information.

To achieve the above objects, according to an embodiment of the present invention, a method for decoding an image comprises receiving encoded data; obtaining object information for separating objects in the image into predetermined units depending on the depth information from a header of the encoded data; decoding the encoded data using the obtained object information; and obtaining a 2D normal image from the decoded data using the depth information.

To achieve the above objects, according to an embodiment of the present invention, a method for decoding an image comprises receiving encoded data; parsing type information for identifying a type of a network abstraction layer unit included in the encoded data; in a case where the parsed type information is associated with an object map, obtaining an object map from the encoded data; and decoding an image bitstream from the encoded data using the obtained object map.

According to an embodiment of the present invention, a 2D image is encoded and decoded using a depth information image obtained by a depth information camera, thus enhancing encoding efficiency of 2D images.

### BRIEF DESCRIPTION OF THE DRAWINGS

FIG. 1 is a view illustrating an exemplary actual image and an exemplary depth information map image;

FIG. 2 illustrates a basic structure of a 3D video system and a data form;

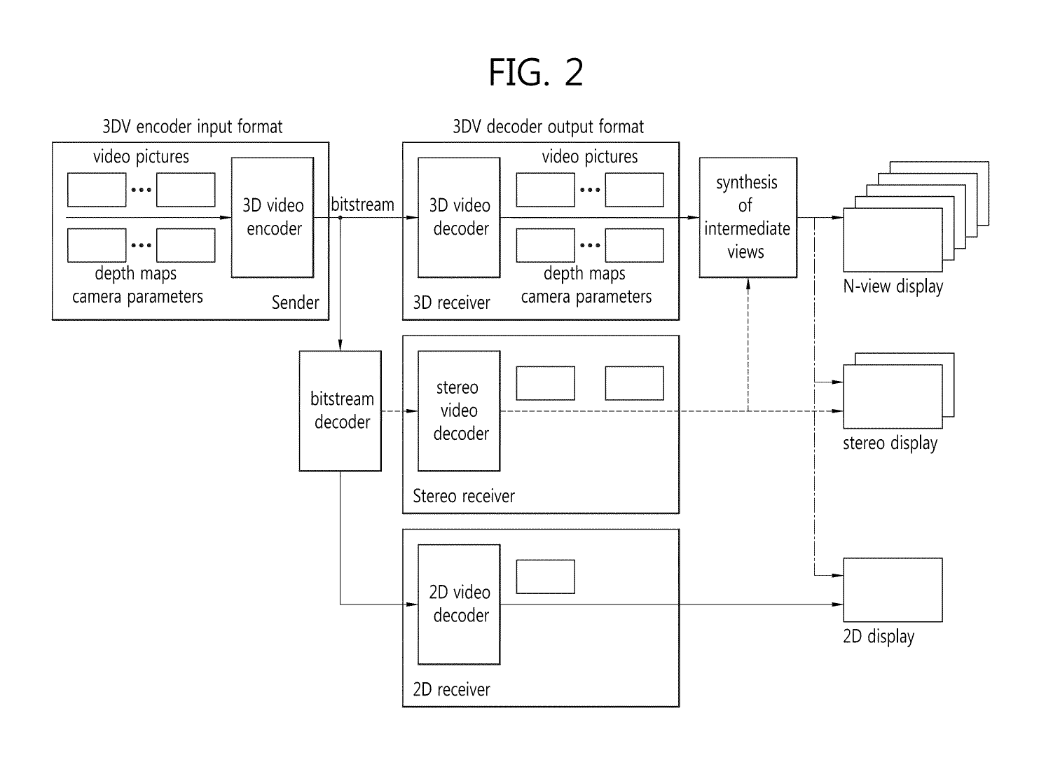

FIG. 3 illustrates a Kinect input device, where (a) indicates a Kinect, and (b) indicates depth information processing through the Kinect;

FIG. 4 illustrates an example of a camera system equipped with a depth information camera;

FIG. 5 illustrates an example of a structure of a video encoder in a video system with a depth information camera;

FIG. 6a illustrates an example of a structure of a video decoder in a video system with a depth information camera;

FIG. 6b illustrates an encoding/decoding method according to an embodiment of the present invention;

FIG. 6c illustrates an encoding/decoding method according to another embodiment of the present invention;

FIG. 6d illustrates an encoding/decoding method according to still another embodiment of the present invention;

FIG. 7a illustrates an example in which a moving object and an object map for a background are represented in a single image or an example in which they are separated according to an embodiment of the present invention;

FIG. 7b illustrates an example in which a moving object and an object map for a background are represented in a single image or an example in which they are separated according to another embodiment of the present invention;

FIG. 7c illustrates object information for separating objects into predetermined units according to an embodiment of the present invention;

FIG. 7d illustrates object information for separating objects into predetermined units according to another embodiment of the present invention;

FIG. 7e illustrates object information for separating objects into predetermined units according to still another embodiment of the present invention;

FIG. 7f illustrates object information for separating objects into predetermined units according to still another embodiment of the present invention;

FIG. 8 illustrates an example of order of a bitstream for transmitting object information on a depth information image in units of images;

FIG. 9 illustrates another example of order of a bitstream for transmitting object information on a depth information image in units of images;

FIG. 10 illustrates an example of order of a bitstream for transmitting object information on a depth information image in units of blocks;

FIG. 11 illustrates another example of order of a bitstream for transmitting object information on a depth information image in units of blocks;

FIG. 12 illustrates an example of a method for performing encoding in units of geometrical blocks; and

FIG. 13 illustrates an example of a result of performing encoding in a geometrical form.

### DETAILED DESCRIPTION OF EXEMPLARY EMBODIMENTS

What is described below merely exemplifies the principle of the present invention. Thus, one of ordinary skill in the art, although not explicitly described or shown in this disclosure, may implement the principle of the present invention and invent various devices encompassed in the concept or scope of the present invention. It should be appreciated that all the conditional terms enumerated herein and embodiments are clearly intended only for a better understanding of the concept of the present invention, and the present invention is not limited to the particularly described embodiments and statuses.

Further, it should be understood that all the detailed descriptions of particular embodiments, as well as the principles, aspects, and embodiments of the present invention are intended to include structural and functional equivalents thereof. Further, it should be understood that such equivalents encompass all devices invented to the same function regardless of whether they are known equivalents or equivalents to be developed in the future, i.e., regardless of structures.

Accordingly, it should be understood that the block diagrams of the disclosure represent conceptual perspectives of exemplary circuits for specifying the principle of the present invention. Similarly, it should be appreciated that all the flowcharts, status variation diagrams, or pseudo codes may be substantially represented in computer-readable media, and regardless of whether a computer or processor is explicitly shown, represent various processes performed by the computer or processor.

The functions of various devices shown in the drawings including functional blocks represented in processors or their similar concepts may be provided using dedicated hardware or other hardware associated with proper software and capable of executing the software. When provided by a processor, the functions may be provided by a single dedicated processor, a single shared processor or a plurality of individual processors, and some thereof may be shared.

The explicit use of the term “processor,” “control,” or other similar concepts of terms should not be interpreted by exclusively referencing hardware capable of executing software, but understood as implicitly including, but not limited to, digital signal processor (DSP) hardware, ROMs for storing software, RAMs, and nonvolatile memories. Other known hardware may be included as well.

In the claims of the disclosure, the elements represented as means to perform the functions described in the description section are intended to include all methods for performing functions including all types of software including combinations of circuit elements for performing the functions or firmware/micro codes, and are associated with proper circuits for executing the software to perform the functions. It should be understood that the present invention defined by the claims is associated with functions provided by various enumerated means and schemes required by the claims, and thus, any means that may provide the functions belong to the equivalents of what is grasped from the disclosure.

The foregoing objects, features, and advantages will be apparent from the detailed description taken in conjunction with the accompanying drawings, and accordingly, one of ordinary skill in the art may easily practice the technical spirit of the present invention. When determined to make the subject matter of the present invention unclear, the detailed description of known configurations or functions is omitted.

Hereinafter, preferred embodiments of the present invention are described in detail with reference to the drawings.

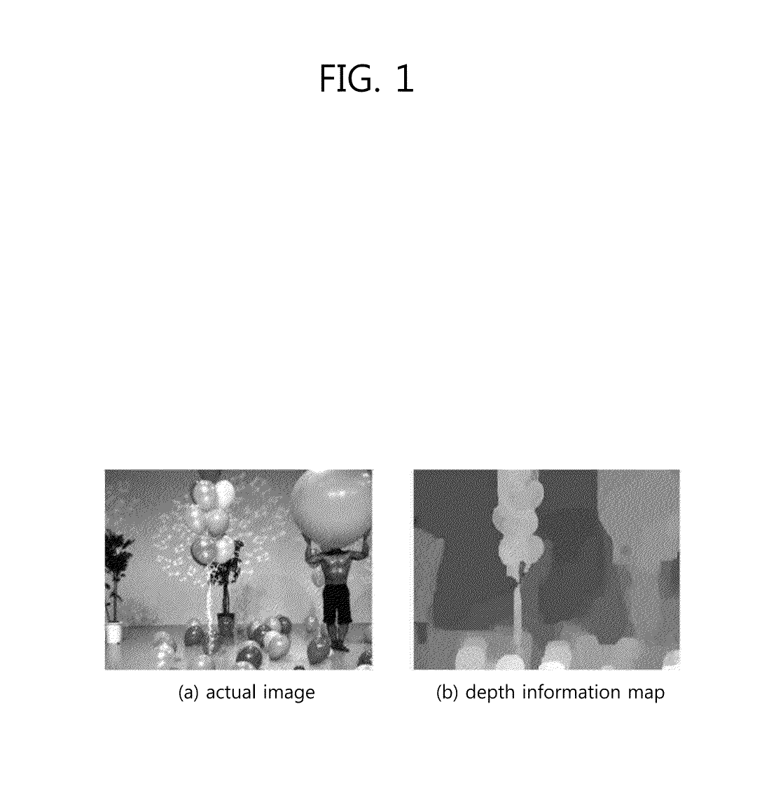

Depth information is information representing the distance between a camera and an actual object. FIG. 1 shows a normal image and its depth information image. FIG. 1 illustrates an actual image and depth information map image for balloons. (a) denotes the actual image, and (b) denotes the depth information map.

The depth information image is primarily used to generate a 3D virtual view image, and in related studies, JCT-3V (The Joint Collaborative Team on 3D Video Coding Extension Development) of ISO/IEC's MPEG (Moving Picture Experts Group) and ITU-T's VCEG (Video Coding Experts Group) currently proceeds with 3D video standardization.

The 3D video standards include standards regarding advanced data formats and their related technologies that allow for replay of autostereoscopic images as well as stereoscopic images using normal images and their depth information images.

The depth information images used in the 3D video standards are encoded together with normal images and are transmitted to a terminal in bit streams. The terminal decodes the bitstreams and outputs the restored N views of normal images and their (the same number of views of) depth information images. In this case, the N views of depth information images are used to generate an infinite number of virtual view images through a depth image based rendering (DIBR) method. The infinite number of virtual view images generated so are played back in compliance with various stereoscopic display apparatuses to provide users with stereoscopic images.

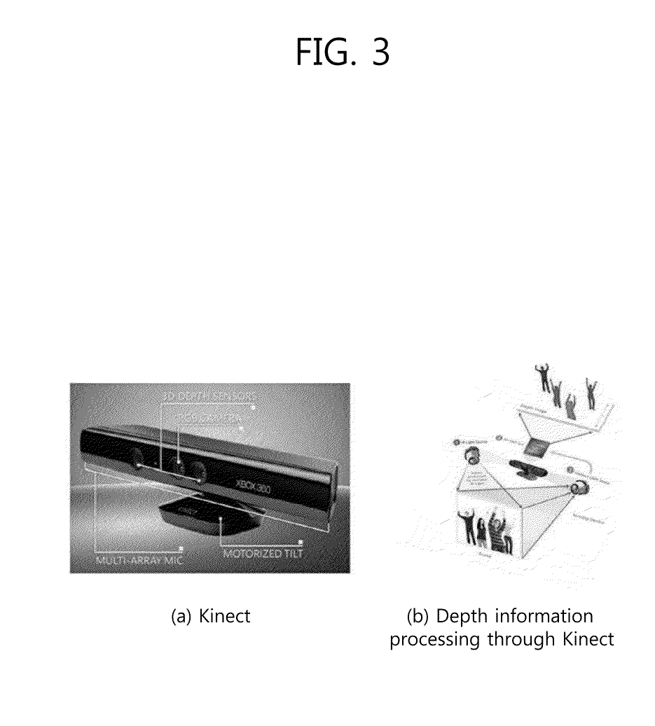

Microsoft launched the Kinect sensor as a brand-new input device for the XBOX-360 game device. This device recognizes a human operation and connects to a computer system. As shown in FIG. 3, the device includes an RGB camera and a 3D depth sensor. Further, the Kinect is an imaging device and may generate RGB images and depth information maps up to 640×480 and provide the same to a computer connected thereto.

FIG. 3 illustrates a Kinect input device. (a) Denotes the Kinect, and (b) denotes depth information processing through the Kinect.

The advent of imaging equipment, such as the Kinect, enabled play of 2D and 3D games and execution of imaging services or other various applications at a lower price than that of high-end video systems. Accordingly, depth information camera-equipped video apparatuses are expected to become commonplace.

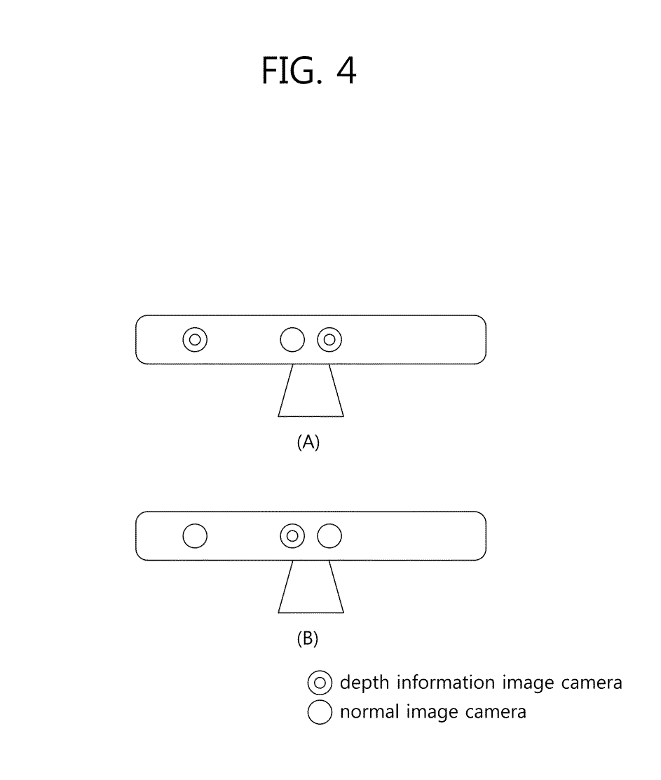

FIG. 4 illustrates an example of a camera system equipped with a depth information camera.

FIG. 4 illustrates an example of a camera system equipped with a depth information camera. FIG. 4(A) illustrates cameras including one normal image camera and two depth information image cameras, and FIG. 4(B) illustrates cameras including two normal image cameras and one depth information image camera.

As such, future video systems are expected to evolve in the form that they are combined with normal image cameras and depth cameras to basically offer 2D and 3D real life-like image services as well as 2D normal image services. In other words, with such a system, the user may be simultaneously served with 3D real life-like image services and 2D high-definition image services.

In an embodiment, the user using a 2D high-definition service may turn into a 3D real life-like service. In contrast, the user using a 3D real life-like service may turn into a 2D high-definition service (the smart device basically equipped with 2D/3D switching technology and devices).

A video system basically equipped with a normal camera and a depth camera may not only use depth image through a 3D video codec but also use 3D depth information through a 2D video codec.

The algorithms designed for current 2D video codecs fail to reflect use of depth information. However, the encoding method proposed herein is based on the idea that future video systems may be utilized to code 2D high-definition images as well as 3D images using depth information images obtained through depth information cameras already equipped therein.

A camera system with a depth information camera may code normal images using legacy video codecs. Here, examples of the legacy video codecs include MPEG-1, MPEG-2, MPEG-4, H.261, H.262, H.263, H.264/AVC, MVC, SVC, HEVC, SHVC, 3D-AVC, 3D-HEVC, VC-1, VC-2, and VC-3 or other various codecs.

### Embodiment 1

### Image Encoding Using Depth Information

The basic idea of the present invention is to utilize depth information images obtained with a depth information camera to code 2D normal images in order to maximize encoding efficiency for normal 2D images.

In an embodiment, in case objects of a normal image are separated using a depth information image, the encoding efficiency for the normal image may be significantly increased. Here, the objects mean a number of objects and may include a background image. For a block-based encoding codec, several objects may be present in a block, and different encoding methods may apply to objects, respectively, based on depth information images. In this case, information for separating the objects of a 2D normal image (for example, flag information: not depth image pixel information) may be included in a bitstream that transmits encoded 2D images.

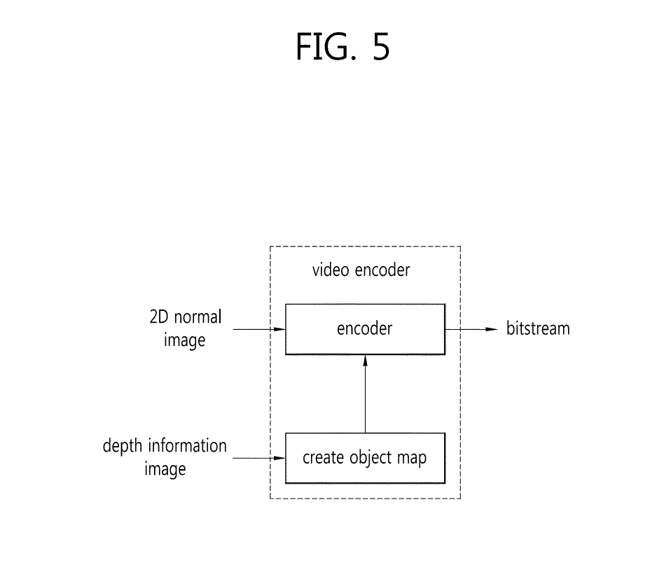

FIG. 5 illustrates an example of a structure of a video encoder in a video system with a depth information camera. In the video encoder shown in FIG. 5, a 2D normal image is encoded using a depth information image. In this case, the depth information image is transformed into an object map form and is used to code the 2D normal image.

To transform the depth information image into the object map form, various methods such as a threshold value scheme, an edge detection scheme, an area growth method, and a scheme using texture feature values may come in use.

In an embodiment, the threshold value scheme, a method of dividing an image with a threshold, is a method in which a histogram is created for a given image, a threshold is determined, and the image is separated into an object and a background. This scheme may present good performance when offering one threshold value, but may not when determining multiple threshold values.

In another embodiment, edge detection may refer to discovery of pixels with discontinuous gray levels in an image. This method comes in two types: a sequential-type method that an earlier calculated result influences a subsequent calculation, and a parallel-type method that whether a pixel has an edge is affected only by its neighbor pixel to allow for parallel calculation. There are a great number of operators in the edge detection scheme, among which a most frequently used operator is an edge operator mainly adopting a first-order differentiated Gaussian function.

In another embodiment, the area growth scheme is a method in which the similarity between pixels is measured, and the area is expanded and split. In general, the area growth scheme may be inefficient in case there are severe variations in gray levels of pixels in an object when setting an absolute threshold and measuring the similarity between neighboring pixels and the border between the object and background is unclear.

Still another embodiment is a method using texture feature values for quantifying discontinuous variations in pixel values of an image. Splitting using only texture features benefits in light of speed, but this method may be inefficient in splitting if different features are gathered in one area or the border between the features is unclear.

Such object map-related information is included in a bitstream and transmitted. Depth information is used for encoding 2D normal images, but not for encoding 3D images. Therefore, rather than depth information images themselves being encoded and transmitted in bitstreams, only basic information (not depth information images themselves) for utilizing the object map on the end of decoder may be included in bitstreams and transmitted.

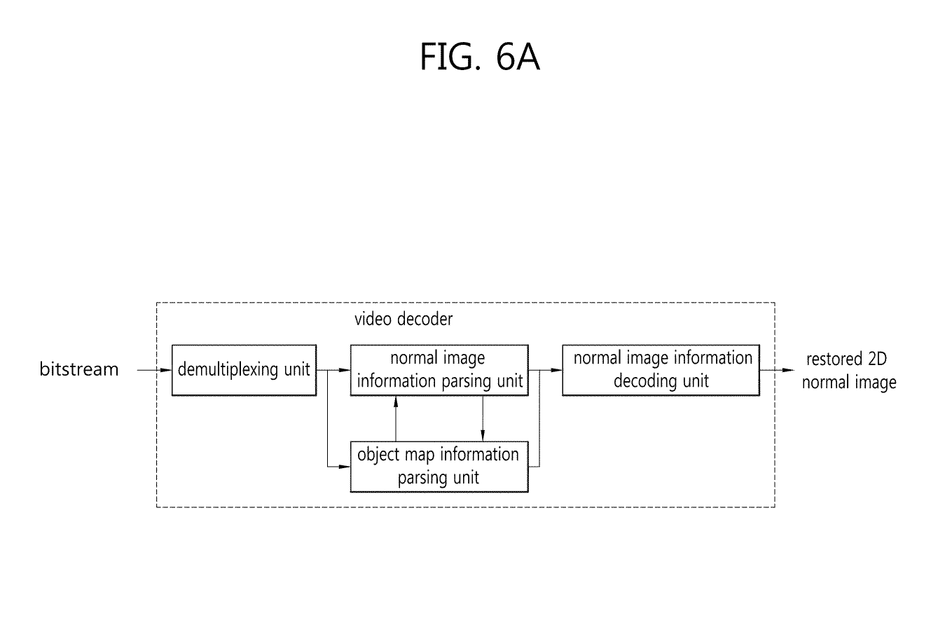

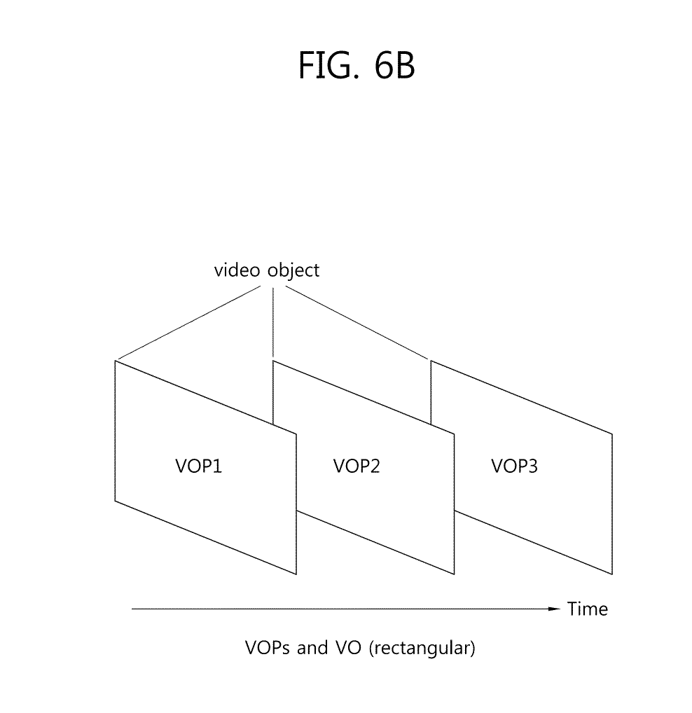

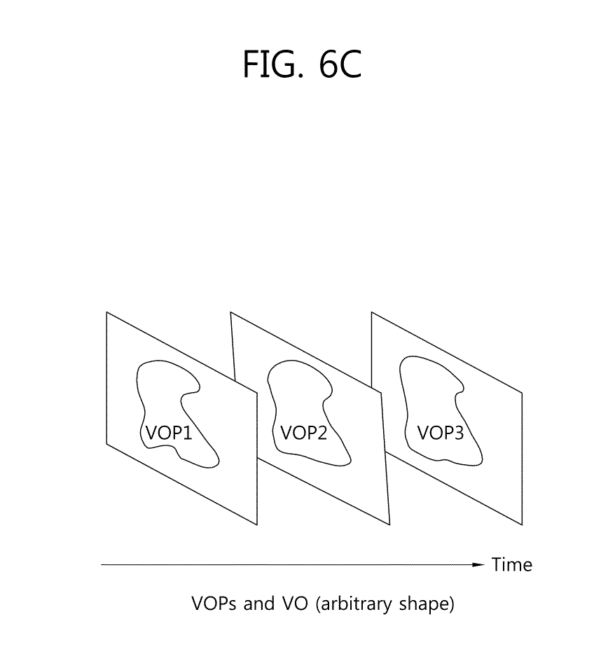

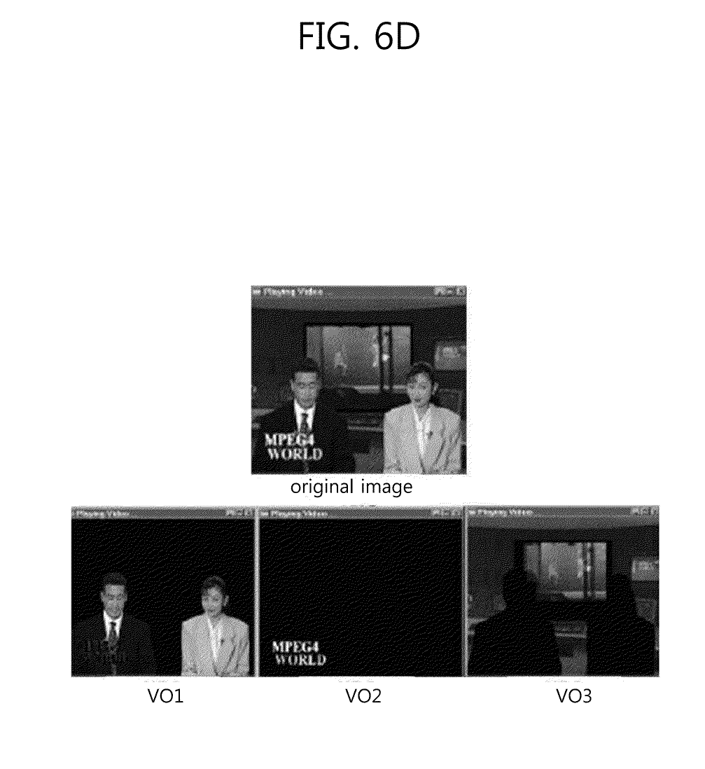

FIG. 6a illustrates an example of a structure of a video decoder in a video system with a depth information camera. The video decoder receives a bitstream, demultiplexes the bitstream, and parses the normal image information and object map information.

In this case, the object map information may be used to parse the normal image information, and reversely, the parsed normal image information may be used to create an object map. This may apply in various manners.

1) In an embodiment, a normal image information parsing unit and an object map information parsing unit are parsed independently from each other.

2) In another embodiment, normal image information is parsed using the parsed object map information.

3) In still another embodiment, object map information is parsed using the parsed normal image information.

Besides, the parsing unit may apply in various methods.

The parsed object map information is input to a normal image information decoder and is used to decode the 2D normal image. Finally, the normal image information decoder outputs the 2D normal image restored by performing decoding using the object map information.

In this case, the decoding using the object map information is performed on a per-object basis. In an existing encoding scheme, the overall frame (image or picture) means one object as shown in FIG. 6b, while in the per-object encoding/decoding, any type of object is meant to be encoded/decoded as shown in FIG. 6c. In this case, video object (VO) may be a partial area of a video scene and may be present in any shaped area, and may exist for a time. A VO at a particular time is denoted a VOP (Video Object Plane).

FIG. 6b illustrates an example of a per-frame encoding/decoding method, and FIG. 6c illustrates an example of a per-object encoding/decoding method.

FIG. 6b shows one VO consisting of three rectangular VOPs. In contrast, FIG. 6c shows one VO consisting of three VOPs each having an irregular shape. Each VOP may be present in a frame, and may be independently subjected to object-based encoding.

FIG. 6d illustrates an embodiment in which one frame is separated into three objects in per-object encoding. In this case, each object (V01, V02, and V03) is independently encoded/decoded. Each independent object may be encoded/decoded with a different picture quality and temporal resolution to reflect its importance to the final image. Objects obtained from several sources may be combined in one image.

Meanwhile, in case there are a plurality of object maps, a definition for the case where separation is made into a background object and an object for a moving thing may be added. Further, in an embodiment, a definition for the case where separation is made into a background object, an object for a moving thing, and an object for text, may be added as well.

In case no object map information is transferred from the encoder to the decoder, an object map may be created using the information already decoded by the decoder (normal image or other information). The object map created so by the decoder may be used to decode a next normal image. However, creation of an object map in the decoder may increase the complexity of the decoder.

Meanwhile, the decoder may decode normal images using an object map or may decode normal images even without using an object map. Information on whether to use an object map may be included in a bitstream, and such information may be contained in VPS, SPS, PPS, or Slice Header.

The decoder may generate a depth information image using the object map information and use the generated depth information image for a 3D service. An embodiment of a method for generating a depth information image using object map information is to generate a depth information image by allocating different depth information values to objects in an object map. In this case, the allocation of the depth information values may depend on the characteristics of objects. That is, depending on the characteristics of objects, higher or lower depth information values may be allocated.

### Embodiment 2

### Method for Configuring Bitstream

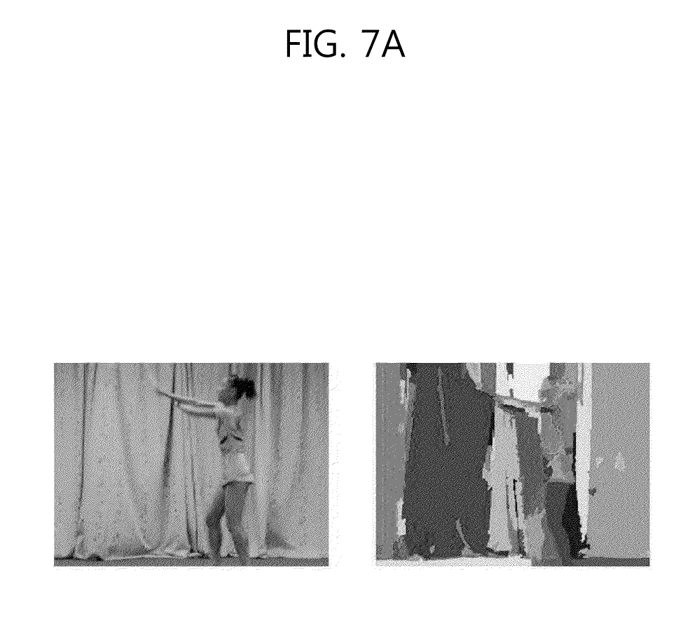

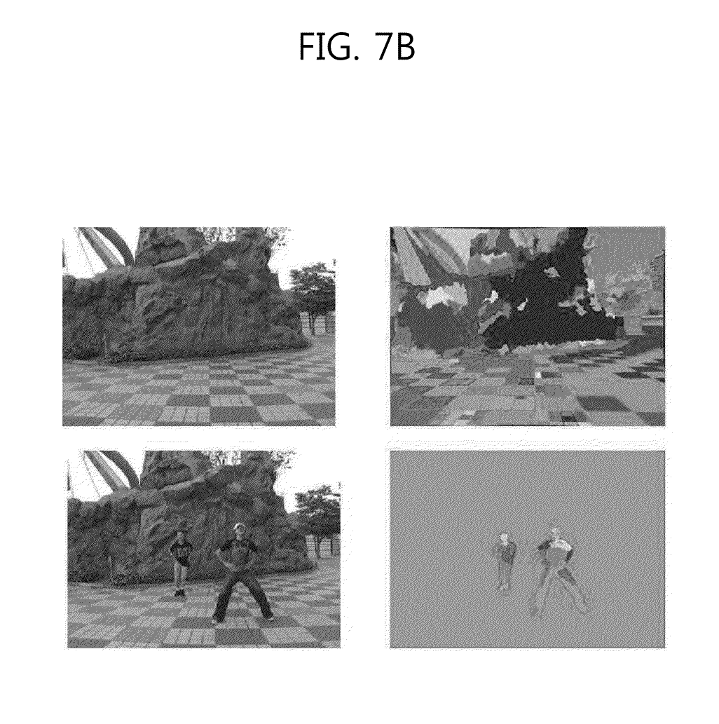

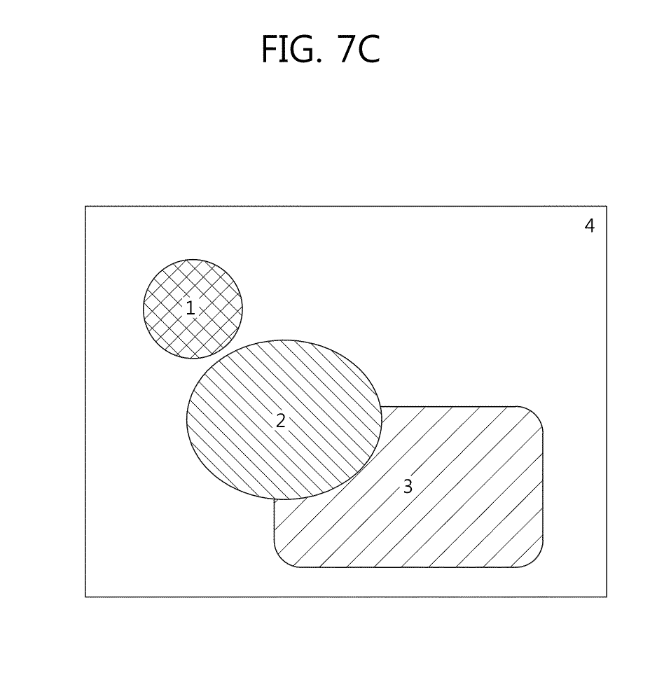

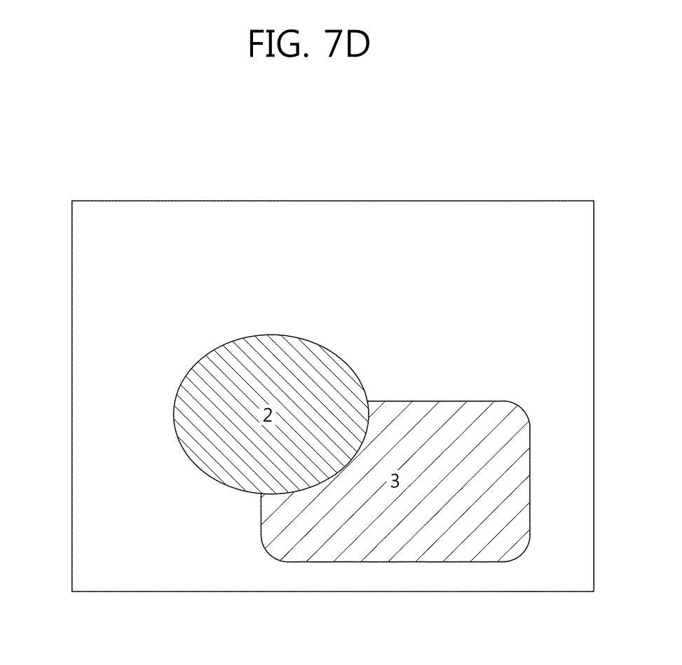

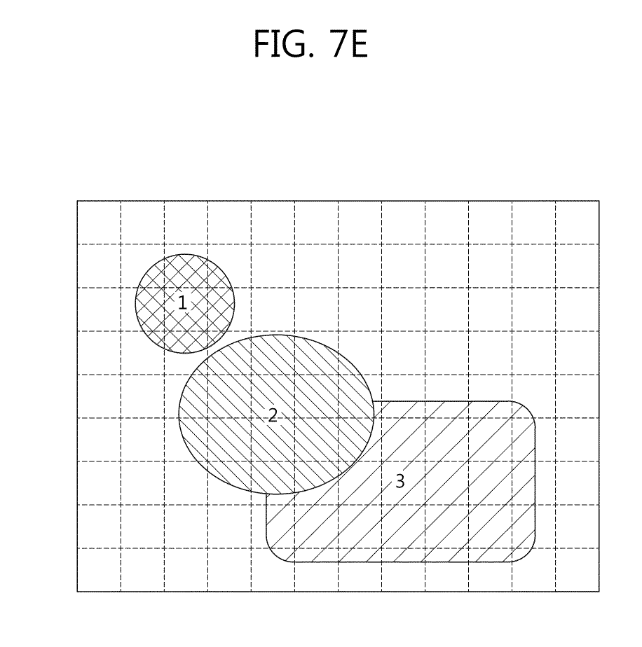

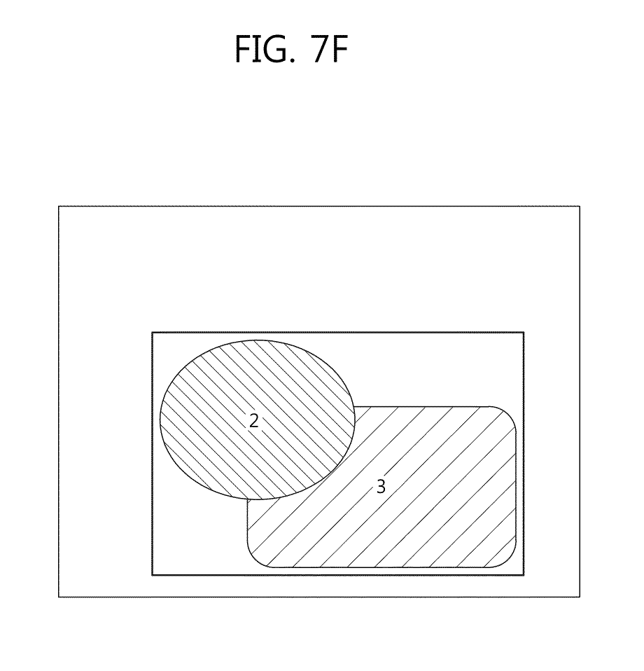

Upon using a depth information image to code a 2D normal image, the depth information image may be transformed into an object map form and may be used. The object map may come in the case in which a moving object and an object map for a background are represented in a single image or the case in which they are separated. In an embodiment, FIG. 7a illustrates the case where a moving object and an object map for a background both are represented in one image. In another embodiment, FIG. 7b illustrates the case where a moving object and an object map for a background are represented in different images, respectively.

The object map may be calculated or separated in units of images, in units of arbitrary shapes, in units of blocks, or in units of any areas.

First, in case an object map for a depth information image is transmitted in units of images, information for differentiating the objects through labeling may be transmitted.

FIG. 7c illustrates an embodiment of a per-image object map. As shown in FIG. 7c, one image may be separated into four objects. Among them, object 1 is separated from the other objects and is independently present. Objects 2 and 3 overlap each other. Object 4 represents the background.

Second, in case an object map for a depth information image is transmitted in units of arbitrary shapes, information for differentiating the labeled objects may be transmitted.

FIG. 7d illustrates an embodiment for information for differentiating objects in units of arbitrary shapes.

Third, in case an object map for a depth information image is transmitted in units of blocks, information for differentiating the objects labeled only in the block area may be transmitted.

FIG. 7e illustrates an embodiment for information for differentiating objects in units of blocks. As shown in FIG. 7e, an object map for the area where objects are present in units of blocks may be transmitted.

Fourth, in case an object map for a depth information image is transmitted in units of any areas, information for differentiating the objects labeled only for any area where there are moving objects may be transmitted.

FIG. 7f illustrates an embodiment for information for differentiating objects in units of any areas. As shown in FIG. 7c, an object map for an area where objects are present (for example, area including object 2 and object 3) may be transmitted.

Here, the information for differentiating objects may be represented in labeled information and transmitted, or information for differentiating objects by other methods may be transmitted. Various changes may be made to the method for representing the object map.

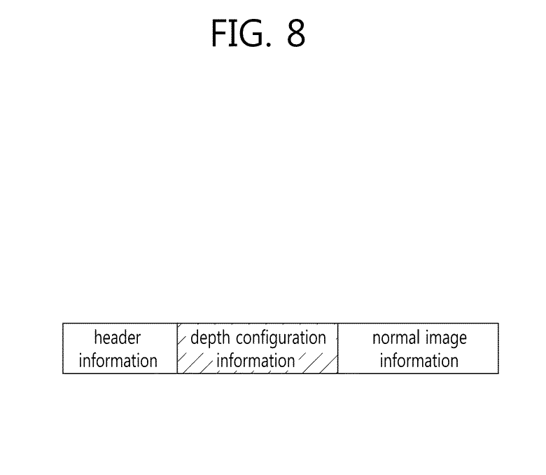

FIG. 8 illustrates an example of order of a bitstream for transmitting object information on a depth information image in units of images. The header information may include information on parameters necessary to decode normal image information and depth configuration information. The depth configuration information may include information for differentiating objects through labeling (or information for differentiating objects by other methods). The depth configuration information may be encoded/decoded by applying an encoding method for normal images or applying shape encoding of MPEG-4 Part 2 Visual (ISO/IEC 14496-2). Such depth configuration information may be used to decode normal images. The normal image information may contain information for restoring normal images (e.g., encoding mode information, intra-screen direction information, motion information, residual signal information).

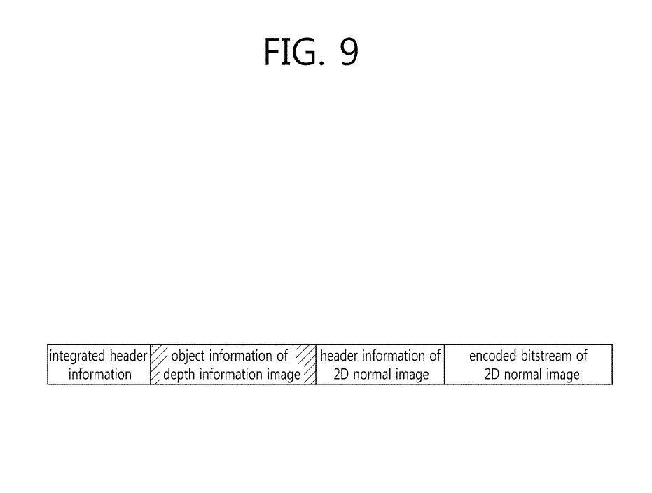

FIG. 9 illustrates another example of order of a bitstream for transmitting object information on a depth information image in units of images. The header information of FIG. 8 may include information on parameters necessary to decode object information of depth information images and 2D normal images. The object information of depth information images includes information for differentiating objects through labeling (or information for differentiating objects by other methods). Further, the object information of depth information images may include information for differentiating objects for depth information images in units of any areas or in units of arbitrary shapes. The object information of depth information images may be encoded/decoded by applying an encoding method for normal images or applying shape encoding of MPEG-4 Part 2 Visual (ISO/IEC 14496-2). The object information of depth information images may be used to decoder the header information of 2D normal images or used to decode information for restoring 2D normal images (e.g., encoding mode information, intra-screen direction information, motion information, or residual signal information). The header information of 2D normal images may contain information on parameters necessary to decode 2D normal images. The encoded bitstream of a 2D normal image may contain information for restoring the 2D normal image (e.g., encoding mode information, intra-screen direction information, motion information, residual signal information).

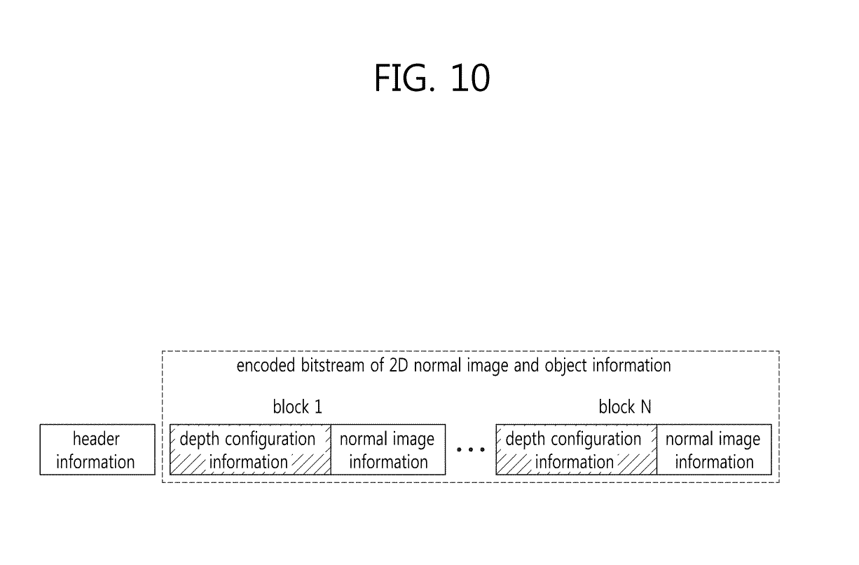

FIG. 10 illustrates an example of order of a bitstream for transmitting depth configuration information in units of blocks. The header information of FIG. 10 may include information on parameters necessary to decode depth configuration information and 2D normal images. The depth configuration information may include information for differentiating objects through labeling in units of blocks (or information for differentiating objects by other methods). The depth configuration information may be encoded/decoded by applying an encoding method for normal images or applying shape encoding of MPEG-4 Part 2 Visual (ISO/IEC 14496-2). Such depth configuration information may be used to decode normal image blocks. The normal image information may contain information for restoring blocks of 2D normal images (e.g., encoding mode information, intra-screen direction information, motion information, residual signal information).

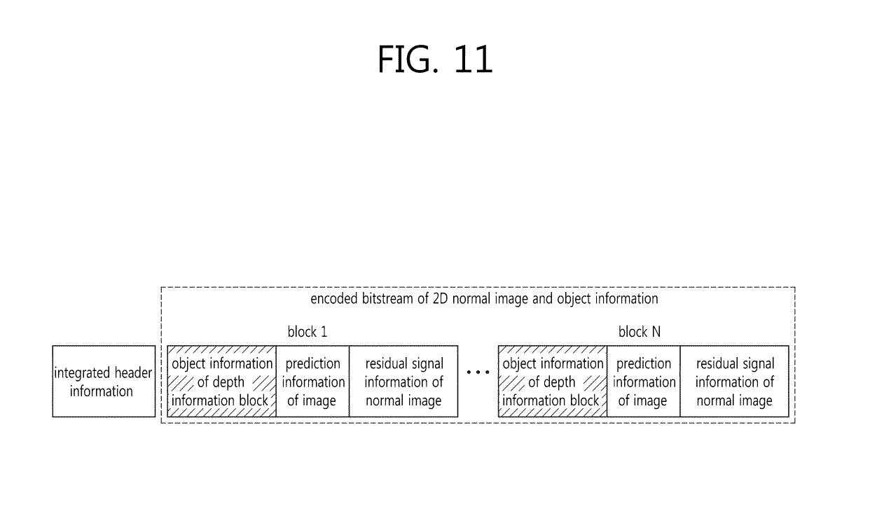

FIG. 11 illustrates still another example of order of a bitstream for transmitting object information on a depth information image in units of blocks. The integrated header information of FIG. 11 may include information on parameters necessary to decode object information of depth information blocks and 2D normal images. The object information of depth information blocks includes information for differentiating objects through labeling in units of blocks (or information for differentiating objects by other methods). The object information of depth information blocks may be encoded/decoded by applying an encoding method for normal images or applying shape encoding of MPEG-4 Part 2 Visual (ISO/IEC 14496-2). The object information of depth information blocks may be used to decoder the header information of images or used to decode information for restoring normal images (e.g., encoding mode information, intra-screen direction information, motion information, or residual signal information). The prediction information of images may contain prediction information necessary for restoring 2D normal images (e.g., encoding mode information, intra-screen direction information, or motion information). Residual signal information of normal images may contain residual signal information for 2D normal images.

### Embodiment 3

### Signaling Method

The above-proposed method differs from the legacy normal image encoding scheme in light of using depth configuration information to code normal images based on objects. Accordingly, a need exists for different signaling methods between images applied with the proposed method and images applied with the legacy method.

Images applied with the proposed method may be newly defined in nal_unit_type and may be signaled. A NAL (Network Abstract Layer) contains header information for differentiating VCLs (Video Coding Layers) including a bitstream of an encoded image and Non-VCLs including information for images necessary for encoding and decoding the images (for example, width and height of images). There may be various types of VCLs and Non-VCLs and the types may be differentiated by nal_unit_type. Accordingly, the proposed signaling method may make distinctions from the bitstream of normal images encoded by the legacy method by newly defining nal_unit_type for bitstreams obtained by encoding normal images based on depth configuration information.

TABLE 1

| nal_unit_type | Name of nal_unit_type | Content of NAL unit and RBSP syntax structure | NAL unit type class |
|---|---|---|---|
| 01 | TRAIL_NTRAIL_R | Coded slice segment of a non-TSA, non-STSA | VCL |
| | | trailing pictureslice_segment_layer_rbsp( ) | |
| 23 | TSA_NTSA_R | Coded slice segment of a TSA | VCL |
| | | pictureslice_segment_layer_rbsp( ) | |
| 45 | STSA_NSTSA_R | Coded slice segment of an STSA | VCL |
| | | pictureslice_layer_rbsp( ) | |
| 67 | RADL_NRADL_R | Coded slice segment of a RADL | VCL |
| | | pictureslice_layer_rbsp( ) | |
| 89 | RASL_NRASL_R | Coded slice segment of a RASL | VCL |
| | | pictureslice_layer_rbsp( ) | |
| 101214 | RSV_VCL_N10RSV_VCL_{—} | Reserved non-IRAP sub-layer non-reference VCL | VCL |
| | N12RSV_VCL_N14 | NAL unit types | |
| 111315 | RSV_VCL_R11RSV_VCL_{—} | Reserved non-IRAP sub-layer reference VCL | VCL |
| | R13RSV_VCL_R15 | NAL unit types | |
| 161718 | BLA_W_LPBLA_W_{—} | Coded slice segment of a BLA | VCL |
| | RADLBLA_N_LP | pictureslice_segment_layer_rbsp( ) | |
| 1920 | IDR_W_RADLIDR_N_{—} | Coded slice segment of an IDR | VCL |
| | LP | pictureslice_segment_layer_rbsp( ) | |
| 21 | CRA_NUT | Coded slice segment of a CRA | VCL |
| | | pictureslice_segment_layer_rbsp( ) | |
| 2223 | RSV_IRAP_VCL22RSV_{—} | Reserved IRAP VCL NAL unit types | VCL |
| | IRAP_VCL23 | | |
| 24 . . . 31 | RSV_VCL24 . . . RSV_{—} | Reserved non-IRAP VCL NAL unit types | VCL |
| | VCL31 | | |
| 32 | VPS_NUT | Video parameter setvideo_parameter_set_rbsp( ) | non-VCL |
| 33 | SPS_NUT | Sequence parameter setseq_parameter_set_rbsp( ) | non-VCL |
| 34 | PPS_NUT | Picture parameter setpic_parameter_set_rbsp( ) | non-VCL |
| 35 | AUD_NUT | Access unit delimiteraccess_unit_delimiter_rbsp( ) | non-VCL |
| 36 | EOS_NUT | End of sequenceend_of_seq_rbsp( ) | non-VCL |
| 37 | EOB_NUT | End of bitstreamend_of_bitstream_rbsp( ) | non-VCL |
| 38 | FD_NUT | Filler datafiller_data_rbsp( ) | non-VCL |
| 3940 | PREFIX_SEI_NUTSUFFIX_{—} | Supplemental enhancement informationsei_rbsp( ) | non-VCL |
| | SEI_NUT | | |
| 41 | OBJECT_NUT | Object_dataObject_data_rbsp( ) | VCL (or non-VCL) |
| 42 . . . 47 | RSV_NVCL41 . . . RSV_{—} | Reserved | non-VCL |
| | NVCL47 | | |
| 48 . . . 63 | UNSPEC48 . . . UNSPEC63 | Unspecified | non-VCL |

Table 1 represents an example of the case where per-object encoding type (OBJECT_NUT) is added to HEVC's NAL type.

In Table 1, In the case of OBJECT_NUT NAL type, it may represent that a corresponding bitstream may be interpreted and decoded with an object map. The depth configuration information (or depth information image, block or any area of object information) may be encoded/decoded by applying an encoding method for normal images or applying shape encoding of MPEG-4 Part 2 Visual (ISO/IEC 14496-2). Accordingly, upon application of the encoding method for normal images, data for normal images is, as is, used for Object_data_rbsp( ). Further, upon application of Shape Coding of MPEG-4 Part 2 Visual (ISO/IEC, 14496-2), data for Shape Coding of MPEG-4 Part 2 Visual (ISO/IEC 14496-2) may be used, as is, for Object_data_rbsp( ).

In case where a normal image is encoded in a geometrical form of block

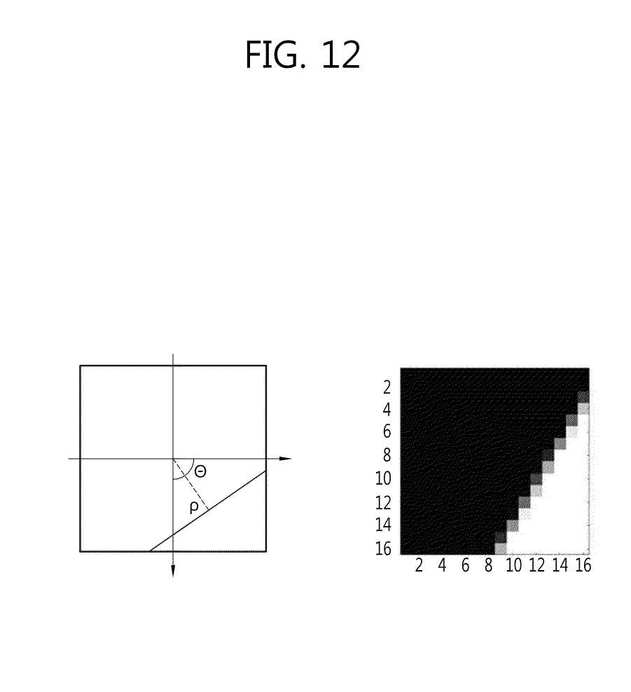

The current video encoding codec codes images in units of rectangular blocks. However, images may be encoded in units of geometrical forms of blocks in the future to enhance encoding efficiency and subjective image quality. FIG. 12 illustrates an example of such a geometrical form. Referring to FIG. 12, a rectangular block is divided into geometrical blocks respectively including a white portion and a black portion with respect to a diagonal line. The geometrical blocks may be subjected to prediction independently from each other.

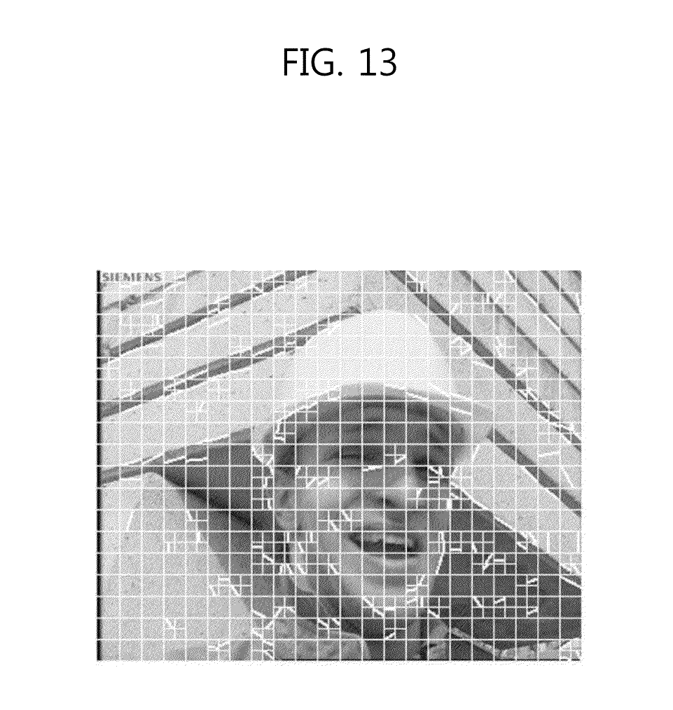

FIG. 13 illustrates an example in which a block is split into geometrical forms in an image encoded in the geometrical form. As shown in FIG. 13, each block may be separated into geometrical forms as shown in FIG. 12, so that each block may be subjected to prediction encoding independently from another.

FIG. 12 illustrates an example of a method for performing encoding in units of geometrical forms of blocks, and FIG. 13 illustrates an example of a result of performing encoding in the geometrical form.

When encoded in the geometrical form, normal images may be object-split as well. Simultaneous use of an object map using depth information images and split information on normal images may maximize the efficiency of encoding 2D normal images. The method for creating an object map using split information on normal images is shown in FIG. 6 and has been already described.

The above-described methods according to the present invention may be prepared in a computer executable program that may be stored in a computer readable recording medium, examples of which include a ROM, a RAM, a CD-ROM, a magnetic tape, a floppy disc, or an optical data storage device, or may be implemented in the form of a carrier wave (for example, transmission through the Internet).

The computer readable recording medium may be distributed in computer systems connected over a network, and computer readable codes may be stored and executed in a distributive way. The functional programs, codes, or code segments for implementing the above-described methods may be easily inferred by programmers in the art to which the present invention pertains.

Although the present invention has been shown and described in connection with preferred embodiments thereof, the present invention is not limited thereto, and various changes may be made thereto without departing from the scope of the present invention defined in the following claims, and such changes should not be individually construed from the technical spirit or scope of the present invention.

1-26. (canceled)

27. A method for decoding an image using depth information, the method comprising:
receiving encoded data;
parsing the depth information from the encoded data; and
decoding the encoded data using the depth information.

28. The method of claim 27, further comprising obtaining a 2D normal image from the data which is decoded by using the depth information.

29. The method of claim 27, wherein the depth information includes an object map, and wherein the object map and 2D image information are independently parsed from the encoded data.

30. The method of claim 27, wherein the depth information includes an object map, and the method further comprising parsing 2D image information based on the parsed object map.

31. The method of claim 27, wherein parsing the depth information includes:
parsing 2D image information from the encoded data; and
parsing the object information from the encoded data based on the parsed 2D image information.

32. A method for decoding an image using depth information, the method comprising:
receiving encoded data;
obtaining from a header of the encoded data, object information for separating objects in the image into predetermined units depending on the depth information; and
decoding the encoded data using the obtained object information.

33. The method of claim 32, further comprising obtaining a 2D normal image from the data which is decoded by using the depth information.

34. The method of claim 32, wherein the predetermined units are units of images, units of blocks, or units of arbitrary forms.

35. The method of claim 32, wherein the header of the encoded data includes parameter information for decoding the depth information.

36. A method for decoding an image using depth information, the method comprising:
receiving encoded data;
parsing type information for identifying a type of a network abstraction layer unit included in the encoded data; and
obtaining an object map from the encoded data when the parsed type information is associated with an object map.

37. The method of claim 36, further comprising decoding an image bitstream from the encoded data by using the obtained object map.

38. The method of claim 36, wherein the type information includes at least one of depth configuration information on the encoded data and object information of a depth information image.

39. The method of claim 37, wherein said decoding includes separating the image bitstream into geometrical blocks based on the object map and performing independent prediction decoding on the separated blocks.
